(19) United States
(12) Patent Application Publication
(10) Pub. No.: US 2026/0106406 A1
(43) Pub. Date: Apr. 16, 2026

(54) BI-DIRECTIONAL SELF-ALIGNMENT CONNECTOR

(71) Applicant: HYUNDAI MOBIS CO., LTD., Seoul (KR)

(72) Inventors: Young Jun KIM, Yongin-si (KR); Kwon Il CHO, Yongin-si (KR)

(73) Assignee: HYUNDAI MOBIS CO., LTD., Seoul (KR)

(21) Appl. No.: 19/264,478

(22) Filed: Jul. 9, 2025

(30) Foreign Application Priority Data
Oct. 15, 2024 (KR) 10-2024-0140396

(51) Int. Cl. H01R 13/631; H01R 13/514; H01R 13/64

(52) U.S. Cl. CPC H01R 13/631; H01R 13/514; H01R 13/64

(57) ABSTRACT

A self-alignment connector includes a first connector having a first terminal therein and a second connector having a second terminal therein, into which the first terminal is inserted. The first connector includes a housing including an inner connector portion disposed at a first end of the first connector and coupled with the second connector, and an outer connector portion disposed at a second end of the first connector and coupled with a third connector. The inner connector portion includes an accommodation space accommodating the second connector, and a first plate at a first end of the first terminal within the accommodation space. The outer connector portion includes an accommodation space defined therein and accommodating the third connector, and a second plate at a second end of the first terminal within the accommodation space of the outer connector portion, and the second plate prevents deformation of the first terminal.

### CROSS-REFERENCE TO RELATED APPLICATIONS

This application claims the benefit of Korean Patent Application No. 10-2024-0140396, filed on October 15, 2024, which is hereby incorporated by reference as if fully set forth herein.

### TECHNICAL FIELD

The disclosure relates to a self-alignment connector, and more particularly, to a self-alignment connector which facilitates coupling and separation between connectors.

### BACKGROUND

In general, a connector is a device that electrically connects a power source and a device, a device and a device, and internal units of a device. This connector includes a pair of connectors connectable to each other, that is, a plug connector and a receptacle connector. Terminals for transmitting current and signals are provided inside the plug connector and the receptacle connector.

However, a conventional connector assembly has limitations in significantly improving efficiency and workability because an operator needs to check it visually or tactilely before connecting.

Moreover, the conventional connector assembly suffers from concentration of stress on a specific position of a positioning correction arm during a process of connecting the plug connector and the receptacle connector.

As such, when stress is concentrated at a specific position of the position correction arm during connection between the plug connector and the receptacle connector, this may reduce the strength of a corresponding portion, and in a worse case, cause cracks or damage.

### SUMMARY

An aspect of the disclosure is to provide a self-alignment connector that may prevent cracks or breakage at a specific position by distributing stress applied to a specific connector during coupling between connectors.

Another aspect of the disclosure is to provide a self-alignment connector that may improve coupling stability during coupling between connectors.

The objects to be achieved by the disclosure are not limited to what has been particularly described hereinabove and other objects not described herein will be more clearly understood by persons skilled in the art from the following detailed description.

According to an embodiment of the disclosure, a self-alignment connector includes a first connector having a first terminal therein, and a second connector having a second terminal therein, into which the first terminal is inserted. The first connector includes a housing including an inner connector portion disposed at a first end thereof and coupled with the second connector, and an outer connector portion disposed at a second end thereof and coupled with a third connector. The inner connector portion includes an accommodation space defined therein and accommodating the second connector, and a first plate assembled within the accommodation space at a predetermined first length from a first end of the first terminal, for preventing deformation of the first terminal. The outer connector portion includes an accommodation space defined therein and accommodating the third connector, and a second plate assembled within the accommodation space at a predetermined second length from a second end of the first terminal, for preventing deformation of the first terminal.

Additionally or alternatively, the inner connector portion may include a coupling guide disposed at a front of the accommodation space and having a width increasing towards a front thereof. Herein, the second connector may be accommodated in the accommodation space along the coupling guide.

Additionally or alternatively, the first plate may be configured to move further inward within the accommodation space of the inner connector portion in response to coupling of the first connector with the second connector.

Additionally or alternatively, the second plate may be configured to move further inward within the accommodation space of the outer connector portion in response to coupling of the first connector with the third connector.

Additionally or alternatively, the second connector may include a housing accommodating the second terminal therein, a pair of coupling portions disposed at equal distances from the housing, each coupling portion having a coupling hole disposed thereon for fixing to a vehicle component or a vehicle body, and a tension portion having a bent shape and connecting the housing to the pair of coupling portions.

Additionally or alternatively, the tension portion may be configured to support the housing from below.

Additionally or alternatively, the tension portion may include a pair of support portions extending downward respectively from both ends of a bottom surface of the housing, wherein each of the support portions includes two support plates spaced apart from each other with a distance increasing from the housing, and a bent portion having an S-shape and having a first end connected to one of the support plates of one of the support portions and a second end connected to the coupling portion.

Additionally or alternatively, a first bent portion connected to a support plate of a first support portion of the pair of support portions and a second bent portion connected to a support plate of a second support portion of the pair of support portions may be connected to one of the pair of coupling portions, and the first bent portion and the second bent portion may be symmetrical with respect to the housing.

Additionally or alternatively, the tension portion may include a connecting portion connecting the bent portion to the coupling portion.

Additionally or alternatively, the tension portion may be configured to enable the housing to move in at least one of a first direction in which the housing is connected to the first connector or two directions perpendicular to the first direction.

The above-described solution of the disclosure is a part of embodiments of the disclosure. Various solutions in addition to the above solution may be derived and understood based on the following detailed description of the disclosure.

According to the disclosure, a self-alignment connector is provided, which may prevent cracks or breakage at a specific position by distributing stress applied to a specific connector during coupling between connectors, thereby enabling an operator to easily couple/fasten the connectors.

According to the disclosure, a self-alignment connector is provided, which may improve coupling stability during coupling between connectors, thereby enabling an operator to easily couple/fasten the connectors.

Further, according to the disclosure, a wire for connecting between a connector connected to a vehicle and a connector connected to the inside of a product is deleted such that bi-directional connection is enabled, thereby improving cost reduction.

Further, according to the disclosure, a self-alignment connector is located to suit the structural characteristics of a product and reflects various designs, which enables extended deployment.

Further, according to the disclosure, as a tension portion of a self-alignment connector is shaped such that the tension portion may be located inward and reduced under the self-alignment connector, the self-alignment connector may be applied as a compact one to various products through miniaturization.

Further, according to the disclosure, a moving plate is applied to the side of a male terminal of a bi-directional self-alignment connector, such that the moving plate is located approximately 1.5mm from an end of the terminal before a counterpart connector is coupled, and assembled inward when the counterpart connector is coupled, guiding the correct assembly of the male terminal. Accordingly, chronic problems of terminal deformation and displacement are overcome.

The effects that are achievable by the disclosure are not limited to what has been particularly described hereinabove and other advantages not described herein will be more clearly understood by persons skilled in the art from the following description.

### BRIEF DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating a self-alignment connector according to the disclosure;

FIG. 2 is an exploded view illustrating a self-alignment connector according to the disclosure;

FIG. 3 is a diagram illustrating a self-alignment connector according to another embodiment of the disclosure;

FIG. 4 illustrates a housing of a first connector according to the disclosure;

FIG. 5 illustrates a housing of a first connector and movement of plates located in the housing according to the disclosure; and

FIGS. 6-8 are diagrams illustrating a second connector in a self-alignment connector according to the disclosure.

### DETAILED DESCRIPTION

Embodiments disclosed herein will be described in detail with reference to the attached drawings. Through the drawings, like reference numerals denote the same or similar components and a redundant description of the components will be avoided.

The suffixes "module" and "unit" used for components in the following description are given or used interchangeably only for the convenience of description, and do not have distinct meanings or roles in themselves. In addition, when describing the embodiments disclosed herein, a detailed description of a related known technology will be omitted lest it should obscure the subject matter of the embodiments.

In addition, the attached drawings are only intended to facilitate easy understanding of the embodiments disclosed herein, and do not limit the technical ideas disclosed in the specification, which should be understood to include all modifications, equivalents, or substitutes included in the scope of the disclosure.

Terms including ordinal numbers such as first, second may be used to describe various components. However, the components are not limited by the terms. The above terms are used only for the purpose of distinguishing one component from another.

When it is said that a component is "coupled" or "connected" to another component, the components should be understood as directly connected or connected with a third component in between. On the other hand, when it is said that a component is "directly coupled" or "directly connected" to another component, it should be understood that there are no other components in between.

A singular expression includes plural referents unless the context clearly indicates otherwise.

In this application, the term "comprise" or "have (has)" is intended to specify the presence of a feature, number, step, operation, component, part, or combination thereof described in the specification, not excluding the possibility of the presence or addition of one or more other features, numbers, steps, operations, components, parts, or combinations thereof.

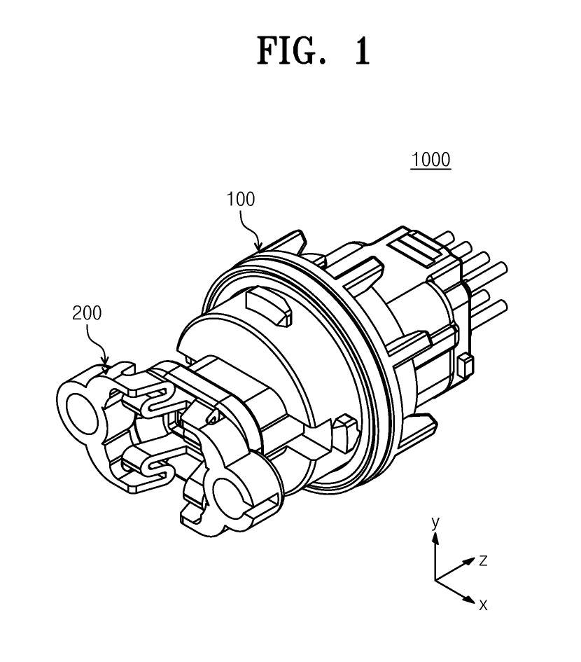

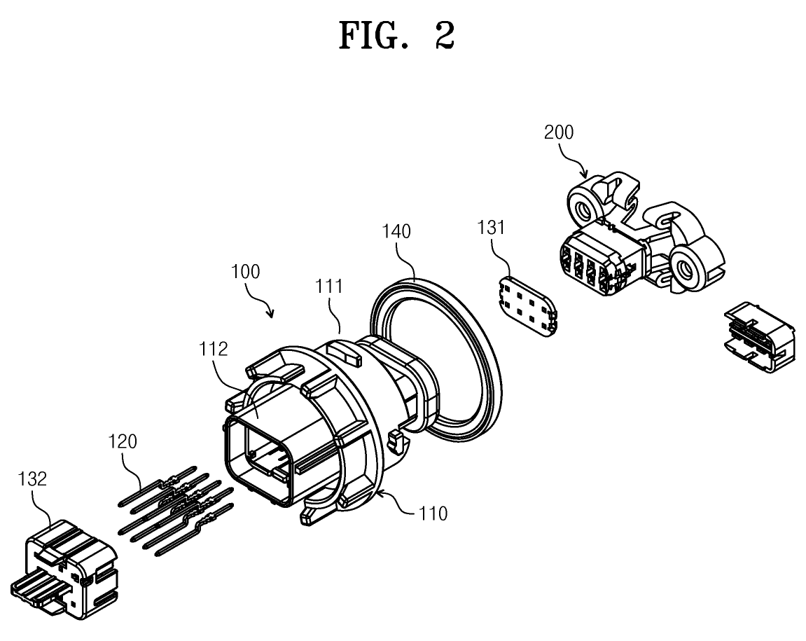

FIG. 1 is a diagram illustrating a self-alignment connector according to the disclosure. FIG. 2 is an exploded view illustrating the self-alignment connector according to the disclosure.

The following description is given below of a self-alignment connector 1000 according to embodiments with the appreciation that a left-right direction is defined as an x-axis direction, an up-down direction is defined as a y-axis direction, and a front or rear direction is defined as a z-axis direction. That is, the self-alignment connector 1000 has a structure in which at least two connectors are coupled with each other, and a direction in which the two connectors are coupled or assembled with each other will be described or illustrated as the z-axis direction.

FIG. 1 is a diagram illustrating a state in which a second connector 200 is coupled with a first connector 100.

Referring to FIGS. 1 and 2, the self-alignment connector 1000 according to embodiments may include the first connector 100 and the second connector 200.

The self-alignment connector 1000 may correspond to a connector installed in a vehicle lamp assembly or the like to transmit current and signals. For example, the second connector 200 may be installed on the side of a vehicle rear lamp bezel (not shown) and correspond to a connector having a female terminal. The first connector 100 may be installed in a vehicle rear lamp housing (not shown) and correspond to a connector having a male terminal.

The first connector 100 may include a housing 110 forming the exterior thereof and a male pin terminal 120 installed inside the housing 110. A locking device (not shown) may be provided inside the housing 110, for fixing the male pin terminal 120 after it is installed inside the housing 110 so that it does not come out.

Like the first connector 100, the second connector 200 may include a housing 210 forming the exterior thereof and a female pin terminal installed inside the housing 210. Similarly, a locking device (not shown) may be provided inside the housing 210, for fixing the female pin terminal 201 after it is installed inside the housing 210 so that it does not come out.

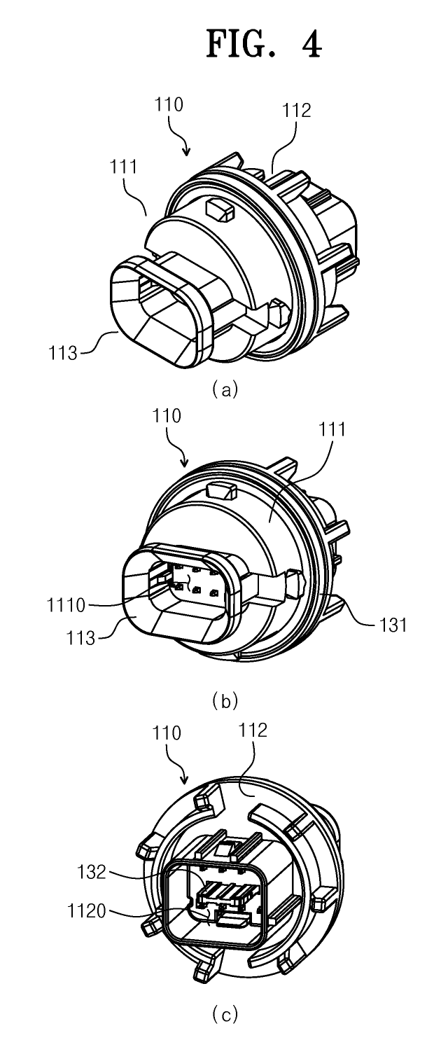

That is, the first connector 100 and the second connector 200 may be coupled with each other by inserting the male pin terminal 120 into the female pin terminal 201. To prevent deformation of the male pin terminal 120 that occurs during the insertion of the male pin terminal 120 into the female pin terminal 201, the housing 110 of the first connector 100 may include plates 131 and 132 (see FIG. 4). The plates 131 and 132 may be formed in a plate shape having a specific strength to prevent the deformation of the male pin terminal 120 caused by the insertion of the male pin terminal 120 into the female pin terminal 201. Further, the plates 131 and 132 may be formed such that a protruding portion of the male pin terminal 120 passes through them, and an insertion portion of the female pin terminal 201 does not pass through them.

In a conventional connector assembly, when the first connector and the second connector are coupled with each other, there is a problem that the first connector and the second connector are not properly coupled due to an incorrect coupling position or the like. Moreover, in the conventional connector assembly, when the first connector and the second connector are coupled with each other, cracks or breakage occur due to a load applied to the first connector or the second connector.

Therefore, the self-alignment connector 1000 according to embodiments may overcome the above problem by providing a tension portion 220 in the second connector 200.

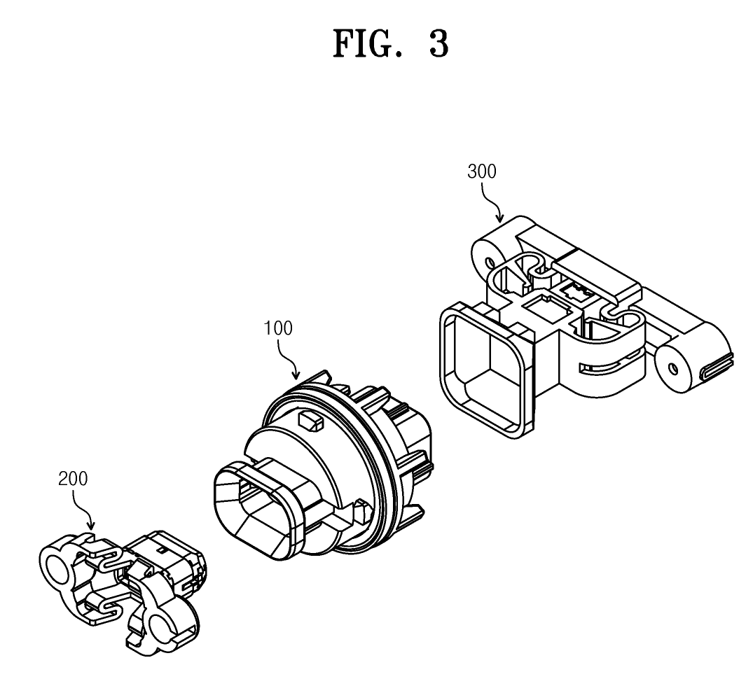

FIG. 3 is a diagram illustrating a self-alignment connector according to another embodiment of the disclosure.

FIG. 3 illustrates a self-alignment connector 1000 in which a third connector 300 is added to the self-alignment connector 1000 illustrated in FIG. 1.

For example, the third connector 300 is a vehicle connector that transmits an electrical signal transmitted from the first connector or an electrical signal to be transmitted to the first connector to or from a vehicle controller through the second connector.

The first connector 100 will be described below in more detail.

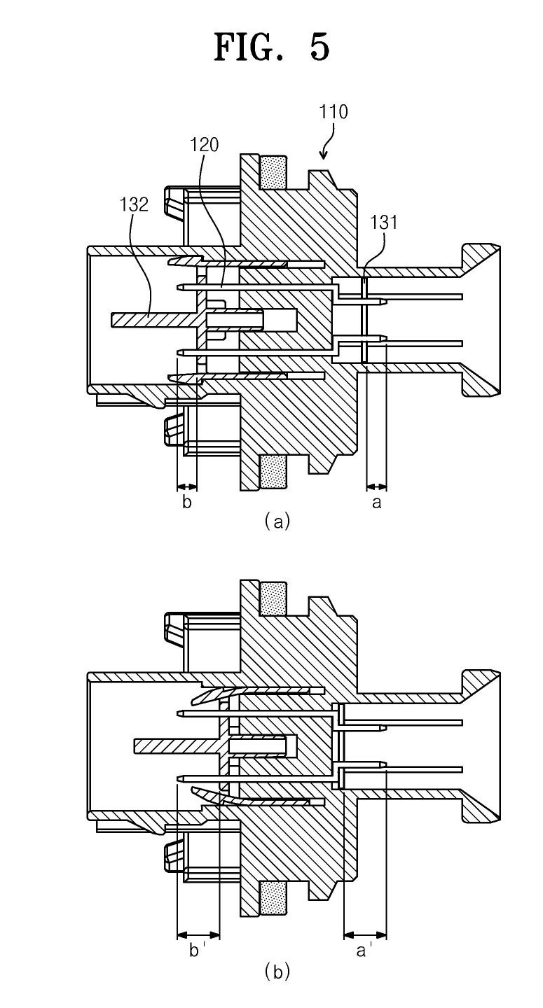

FIG. 4 illustrates a housing of a first connector according to the disclosure. FIG. 5 illustrates the housing of the first connector and movement of moving plates located inside the housing according to the disclosure.

Referring to FIG. 2, the first connector 100 of the self-alignment connector 1000 may include the housing 110, the male pin terminal 120, the plates 131 and 132, and a rim 140.

As described with reference to FIGS. 1 and 2, the housing 110, which is a component forming the exterior of the first connector 100, may accommodate the male pin terminal 120 therein.

The housing 110 may include an inner connector portion 111 and an outer connector portion 112.

The inner connector portion 111, which is a portion coupled with the second connector 200, may include an accommodation space 1110 formed therein, for accommodating the second connector. The accommodation space 1110 may be formed inside the housing 110 and accommodate the second connector 200 in the first direction (z-axis). The second connector 200 may be inserted in the first direction and accommodated in the accommodation space 1110. More specifically, as the second connector 200 is accommodated in the accommodation space 1110, the male pin terminal 120 provided in the first connector 100 may be coupled with the female pin terminal 201 provided in the second connector 200.

The inner connector portion 111 may include a first plate 131 assembled within the accommodation space 1110 at a predetermined first length from an end of the male pin terminal 120 to prevent deformation of the male pin terminal 120.

Further, the inner connector portion 111 may include a coupling guide 113 formed at a front of the accommodation space 1110 and having a width increasing towards a front thereof. The second connector 200 may be accommodated in the accommodation space 1110 along the coupling guide 113.

Further, the outer connector portion 112, which is a portion coupled with the third connector 300, may include an accommodation space 1120 formed therein, for accommodating the third connector 300. The accommodation space 1120 may be formed inside the housing 110 and accommodate the third connector 300 in the first direction (z-axis). The third connector 300 may be inserted in the first direction and accommodated in the accommodation space 1120. More specifically, as the third connector 300 is accommodated in the accommodation space 1120, the male pin terminal 120 provided in the first connector 100 may be coupled with a female pin terminal (not shown) provided in the third connector 300.

The outer connector portion 112 may include a second plate 132 assembled within the accommodation space 1120 at a predetermined second length from the other end of the male pin terminal 120 to prevent deformation of the male pin terminal 120.

Referring to FIG. 4, (a) is a perspective view illustrating the housing 110 of the first connector 100, (b) illustrates the inner connector portion 111 viewed from the front in the first direction, and (c) illustrates the outer connector portion 112 viewed from the rear in an opposite direction to the first direction.

Referring to FIG. 5, a cross-sectional view of the housing 110 is illustrated to describe the plates 131 and 132 according to the disclosure.

FIG. 5 (a) illustrates the positions of the plates before the first connector is coupled with the second connector and the third connector, and FIG. 5 (b) illustrates the positions of the plates after the first connector is coupled with both the second connector and the third connector. The second connector and the third connector are not shown, for simplicity of description.

Referring to FIG. 5 (a), it may be noted that the first plate 131 is accommodated in the accommodation space 1110 of the housing 110 and thus located or assembled inward at a length a from an end of the male pin terminal 120. Referring to FIG. 5 (b), it may be noted that as the second connector is coupled with the first connector, the first plate 131 has moved further inward or deeper (at a length a' from the end of the male pin terminal 120) into the accommodation space 1110 of the housing 110.

Referring to FIG. 5 (a), it may be noted that the second plate 132 is accommodated in the accommodation space 1120 of the housing 110 and thus located or assembled inward at a length b from the other end of the male pin terminal 120. Referring to FIG. 5 (b), it may be noted that as the third connector is coupled with the first connector, the second plate 132 has moved further inward or deeper (at a length b' from the other end of the male pin terminal 120) into the accommodation space 1120 of the housing 110.

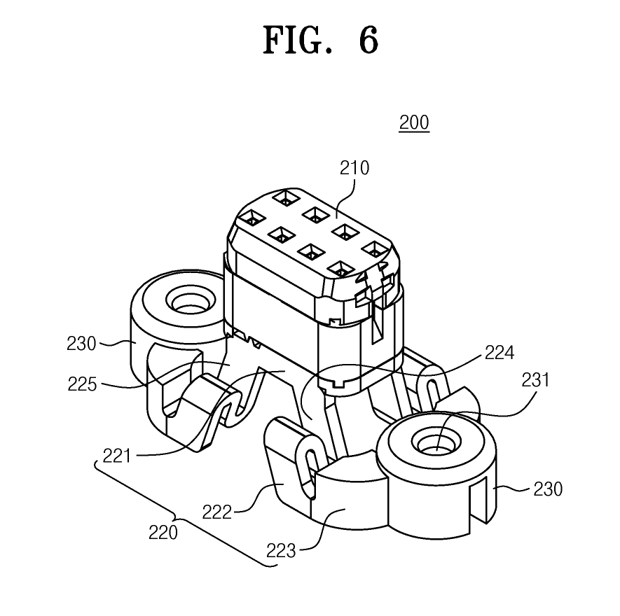

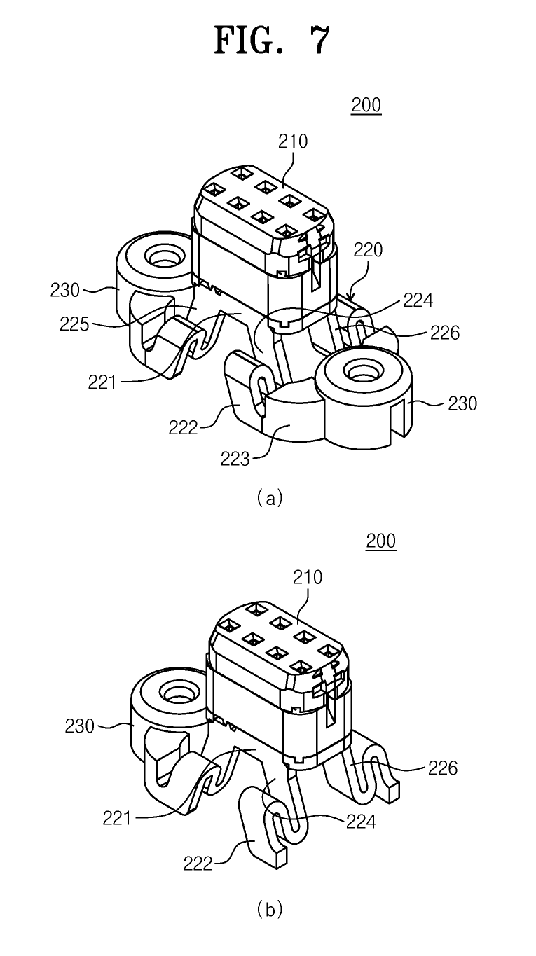

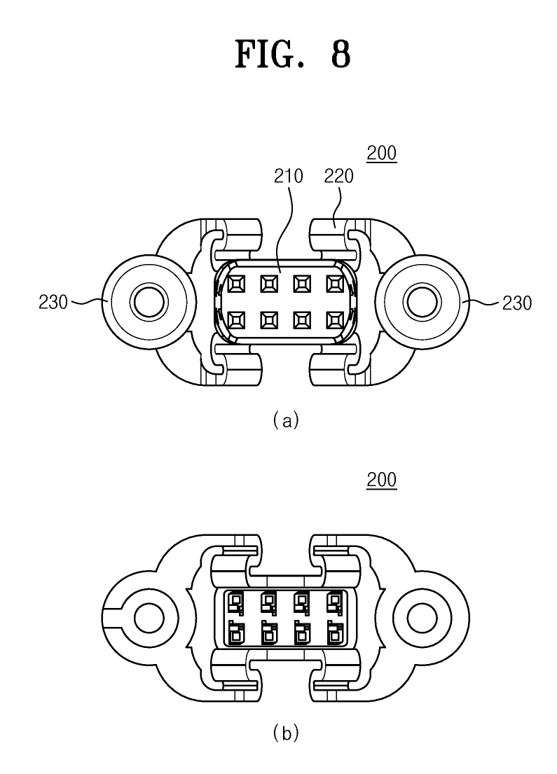

FIGS. 6-8 are diagrams illustrating a second connector of a self-alignment connector according to the disclosure.

Referring to FIG. 6, the second connector 200 of the self-alignment connector 1000 may include the housing 210, the tension portion 220, and a coupling portion 230.

The housing 210, which is a component forming the exterior of the second connector 200, may accommodate the female pin terminal 201 therein. A pair of coupling portions 230 located at equal distances may be formed at the rear of the housing 210. The second connector 200 may be coupled with the side of a vehicle rear lamp housing (not shown) through the coupling portions 230. The housing 210 and the coupling portions 230 may be connected through the tension portion 220.

The tension portion 220 may be formed to support the housing 210 from below, in the first direction (z-axis in FIG. 1), or from the rear of the housing 210.

With the second connector 200 fixed through the coupling portions 230, the tension portion 220 may impart movement to the housing 210. That is, the housing is flexibly moved in at least one of the first direction (z-axis in FIG. 1), a second direction (y-axis in FIG. 1), or a third direction (z-axis in FIG. 1). This brings the effect of self-alignment between the first connector and the second connector and the resulting increase of work efficiency (i.e., productivity).

The tension portion 220 may include a pair of support portions 221 extending downward respectively from one end and the other end of a bottom surface of the housing 210. Each support portion 221 may include two support plates 224 and 225 spaced apart from each other with a distance increasing from the housing 210.

Further, the tension portion 220 may include a bent portion 222 formed in an S-shape, with one end connected to the support plate 224 or 225 and the other end connected to the coupling portion 230. The S-shape of the bent portion 220 provides flexible movement of the housing 210 described above.

Further, a first bent portion connected to the support plate 224 of a first support portion of the pair of support portions 221 and a second bent portion connected to a support plate 226 of a second support portion of the pair of support portions 221 may be connected to one of the pair of coupling portions. Further, the first bent portion and the second bent portion may be located or formed symmetrically with respect to the housing 210.

The tension portion 220 may include a connecting portion 223 connecting the bent portion 222 and the coupling portion 230 to each other.

The coupling portions 230 may include a coupling hole (231) formed thereon for fixing to a vehicle component or a vehicle body.

The detailed description of the preferred embodiments of the disclosure disclosed as described above has been provided to enable those skilled in the art to implement and practice the disclosure. While the disclosure has been described above with reference to preferred embodiments thereof, it will be understood by those skilled in the art that various modifications and variations may be made to the disclosure without departing from the scope of the disclosure. For example, those skilled in the art may utilize the individual components described in the above-described embodiments in a manner that combines them with each other.

Accordingly, the disclosure is not intended to be limited to the embodiments disclosed herein, but is intended to have the broadest scope consistent with the principles and novel features disclosed herein.

What is claimed is:

1. A self-alignment connector comprising:
a first connector having a first terminal therein; and
a second connector having a second terminal therein, into which the first terminal is configured to be inserted,
wherein the first connector includes a housing including an inner connector portion disposed at a first end of the first connector and coupled with the second connector, and an outer connector portion disposed at a second end of the first connector and coupled with a third connector,
wherein the inner connector portion includes an accommodation space defined therein and accommodating the second connector, and a first plate assembled at a first predetermined length from a first end of the first terminal within the accommodation space, wherein the first plate is configured to prevent deformation of the first terminal, and
wherein the outer connector portion includes an accommodation space defined therein and accommodating the third connector, and a second plate assembled at a second predetermined length from a second end of the first terminal within the accommodation space of the outer connector portion, wherein the second plate is configured to prevent deformation of the first terminal.

2. The self-alignment connector of claim 1, wherein the inner connector portion includes a coupling guide disposed at a front of the accommodation space and having a width increasing towards a front of the accommodation space, and
wherein the second connector is accommodated in the accommodation space along the coupling guide.

3. The self-alignment connector of claim 1, wherein the first plate is configured to move further inward within the accommodation space of the inner connector portion in response to coupling of the first connector with the second connector.

4. The self-alignment connector of claim 1, wherein the second plate is configured to move further inward within the accommodation space of the outer connector portion in response to coupling of the first connector with the third connector.

5. The self-alignment connector of claim 1, wherein the second connector includes:
a housing accommodating the second terminal therein;
a pair of coupling portions disposed at equal distances from the housing, each coupling portion having a coupling hole disposed thereon for fixing to a vehicle component or a vehicle body; and
a tension portion having a bent shape and connecting the housing to the pair of coupling portions.

6. The self-alignment connector of claim 5, wherein the tension portion is configured to support the housing from below.

7. The self-alignment connector of claim 5, wherein the tension portion includes:
a pair of support portions extending downward respectively from both ends of a bottom surface of the housing, wherein each of the support portions includes two support plates spaced apart from each other with a distance increasing from the housing; and
a bent portion having an S-shape and having a first end connected to one of the support plates of one of the support portions and a second end connected to the coupling portion.

8. The self-alignment connector of claim 7, wherein the bent portion includes:
a first bent portion connected to a support plate of a first support portion of the pair of support portions; and
a second bent portion connected to a support plate of a second support portion of the pair of support portions,
wherein the first bent portion and the second bent portion are connected to one of the pair of coupling portions, and
wherein the first bent portion and the second bent portion are symmetrical with respect to the housing.

9. The self-alignment connector of claim 7, wherein the tension portion includes a connecting portion connecting the bent portion to the coupling portion.

10. The self-alignment connector of claim 5, wherein the tension portion is configured to enable the housing to move in at least one of a first direction in which the housing is connected to the first connector or two directions perpendicular to the first direction.
